(19) United States
(12) Patent Application Publication
(10) Pub. No.: US 2002/0118095 A1
(43) Pub. Date: Aug. 29, 2002

(54) Shared access personal storage locker apparatus, system and method

(76) Inventor: Lance Estes, Cos Cob, CT (US)

Correspondence Address: Lance Estes, 27 Fado Lane, Cos Cob, CT, 06807, US

(21) Appl. No.: 09/793,686

(22) Filed: Feb. 26, 2001

(51) Int. Cl. H04Q 1/00

(52) U.S. Cl. 340/5.6; 340/5.73

(57) ABSTRACT

A shared access personal storage locker system which includes a smartcard key containing re-writeable memory areas for locker access information, key ID and system ID information, locker storage units of similar or varying sizes containing a bimodal lock apparatus consisting of a key read/write unit for reading and/or writing information in/from the key, a lock control unit for controlling the unlocking and locking of a lock of a personal storage locker, a microcomputer to compare the information from the key to internal lock memory data and a display consisting of Public, Private and Error Message visual prompts . A method for utilizing the personal storage locker system and apparatus are provided in the preferred embodiment in which the programmed key is inserted into the key reader of a personal storage locker, the microcomputer compares the information on the key with the lock's internal memory information, if all rules are met, the locker unit is unlocked. The user opens the locker and places their articles in the locker and then closes the door, whereby the lock control unit actuates the lock and displays Private mode. Only the key that was present in the key reader/writer when the storage unit was locked will now open this storage unit. For taking out articles of this storage unit, the key is again inserted, whereby, after the key is validated, the personal storage unit is unlocked. The user removes their articles from the locker and closes the door whereby the lock control unit actuates the lock returns to Public mode display and clears they key In Use memory area. All personal access rules are stored within the key memory areas. Both the lock and the key store current locker In Use data. The key may store multiple In Use instances whereas the lock will store only one In Use Key ID.

### CROSS-REFERENCE TO RELATED APPLICATIONS

U.S. Pat. No. 5,933,085 August 1999 Holcomb 235/382

U.S. Pat. No. 5,936,544 August 1999 Gonzales 235/382

U.S. Pat. No. 5,979,754 November 1999 Martin 235/382

U.S. Pat. No. 6,116,506 September 2000 Matsumoto 235/492

U.S. Pat. No. 6,157,315 December 2000 Kokubo 340/542

U.S. Pat. No. 6,182,222 January 2001 Oparaji 713/200

U.S. Pat. No. 6,157,229 January 2001 Nielsen 713/200

### BACKGROUND OF THE INVENTION

The present invention relates generally to a system of short-term personal storage lockers of varying sizes to temporarily and securely house items such as bicycles, personal electric vehicles (PEV's), books, groceries, gym clothes, purchases, and outerwear.

A need exists for a conveniently placed system of personal storage lockers, accessible to everyone in the area, to store personal items and personal transportation vehicles, for a minutes or hours, similar to the use of an automobile trunk. While a person is carrying out their daily tasks without a car, it is quite apparent that have a need to store items throughout the day in different locations within a physical area.

They present invention uses a programmed personal key (smartcard) that allows the key holder to travel throughout the installed locker system area and use various types of lockers in different locations while managing the number of lockers used at any one time, all without the need for communication to a central system.

Currently, there are coin operated key locks that are used in airports and single use areas throughout society, as well as private key holder lockers and lockers where you must supply your own lock and key. In addition, smart technology cards are proposed for use with vehicle rental, Internet access, personal computer security and other uses. To date, however, there is no smart technology, bimodal lock system that creates a shared access locker storage system despite the compelling need for one on campuses and other places of public access. Nielsen (U.S. Pat. No. 6,157,229) is a vehicle rental system using a smart card; this system, however, does not allow a user to use multiple locks, nor does it convert a lock from private to public mode.

Matsumoto (U.S. Pat. No. 6,116,506) is a Laundromat key, basically using the smart card as a debit card. This system, however, is not bimodal; a second user could remove the valuables. This invention is unsuitable for a community where people are storing books, purses, bicycles and other valuables. The present invention allows the secure storage and the release of the storage locker for use by another key holder without requiring transmission to a central computer or any manual input by the user.

The present invention will allow for a system of community users that have been issued keys to access storage lockers placed throughout an area without a per use fee. They will be allowed to use any unoccupied locker in the system, as many times as they would like, however they may only use that type of locker if they have not exceeded the number of concurrent locker type uses assigned to that key. This system lets the community user share secure access to lockers at many physical locations throughout the area such as the school, the railroad station, the supermarket, the hospital and the beach, etc.

The present invention allows for a community member to place articles in a locker that is in public mode and change it to private mode anywhere in the system without a central computer access point necessary, and release the locker back to public mode for another community member to use by simply using their key to open the locker each time.

A typical scenario is in a city, town, college or resort where much of the personal transportation is either by public means, bicycle or personal electric vehicle, or by walking. In this scenario, there is no car trunk to lock items in throughout the day. It is necessary to have a secure locker to temporarily store items such as bicycles, packages, groceries, purses, wallets, books and purchases. The ability to move throughout an area and have available secure storage has not previously been addressed.

The costs associated with key management, unknown users articles abandoned, coin collection and traditional accounting have discouraged companies from installing the necessary and wanted storage systems that can now be managed profitably. No more will articles left in a locker require a full time attendant, the key holder who put the articles in the locker can be notified and will already know the procedure for claiming articles left over a pre-determined time. Previous solutions to this storage need have not been feasible

### BRIEF SUMMARY OF THE INVENTION

It is an object of the present invention to provide a community accessed personal storage locker system with public and private modes accessible to anyone holding a community membership key. Such key allows unlimited accesses associated therewith to be performed in a shared access manner using a programmed key, while allowing the lock and key to enforce usage rules without communication to a central system. The key will be used for unlocking the personal storage lockers and controlling the mode of the lock to thereby allow all community member equal access to the storage system.

In view of the above and other objects, which will become apparent as the description proceeds, there is provided according to an aspect of the present invention, a personal storage locker system which includes a smartcard key storing personal usage rules, current in use information, expiration date, pin number and a identification number. Further, there are included: a locker storage unit accommodating therein an article(s), a key read/write unit for reading and/or writing information in/from the key, a lock control unit for controlling locking and unlocking of a mechanical lock mechanism installed on a door of the article storage unit, an identification number storing unit for storing the identification number of the key, a personal usage allowed information storing unit for storing personal usage information, an in use information storage unit for storing current in use information, a usage information storage unit for storing usage history, a clock for comparing the expiration date, a microcomputer to compare the key and lock data, and optionally, a unit for transferring the usage information and to a manually inserted reader/storage device or by wireless transmission of usage information transferred to a data collection unit.

Upon a request to open a locker in Public mode for storage of personal articles or a personal transportation vehicle or the like, the user inserts their programmed key into the lock, the information read from the key is stored in the temporary storage of key data storing unit contained within the lock memory, the rules and expiration date are compared to the appropriate data as controlled by the program logic and implemented by the processor, and if all parameters are met, the lock of the locker unit is unlocked under the control of the lock control unit. The user opens the locker and places articles or a personal transportation vehicle or the like, into the locker. The user closes the locker and the lock control unit locks the lock and the locker changes to Private mode. Further, upon taking out the article from the locker, the lock thereof is unlocked by the key under the control of the lock control unit, the user removes the articles and closes the locker, thereby changing the display of the locker back to Public mode and releasing the key from private use to allow for continued use throughout the system.

### BRIEF DESCRIPTION OF THE SEVERAL VIEWS OF THE DRAWING

In the course of the description that follows, reference is made to the drawings, in which:

FIG. 1 is a block diagram, a general arrangement of the Shared Access lock.

FIG. 2 is a block diagram, a general arrangement of the key issued to all users

FIG. 3a is a block diagram, a flow chart illustrating the steps of operation of the system

FIG. 3b is a block diagram, a flow chart illustrating the steps of the system operation

FIG. 3c is a block diagram, a flow chart illustrating the steps of the system operation

### DETAILED DESCRIPTION OF THE INVENTION

The present invention will be described in detail in conjunction with what is presently considered as preferred or typical embodiments and applications thereof by reference to the drawings. In the following description, like reference characters designate like or corresponding parts throughout the several views.

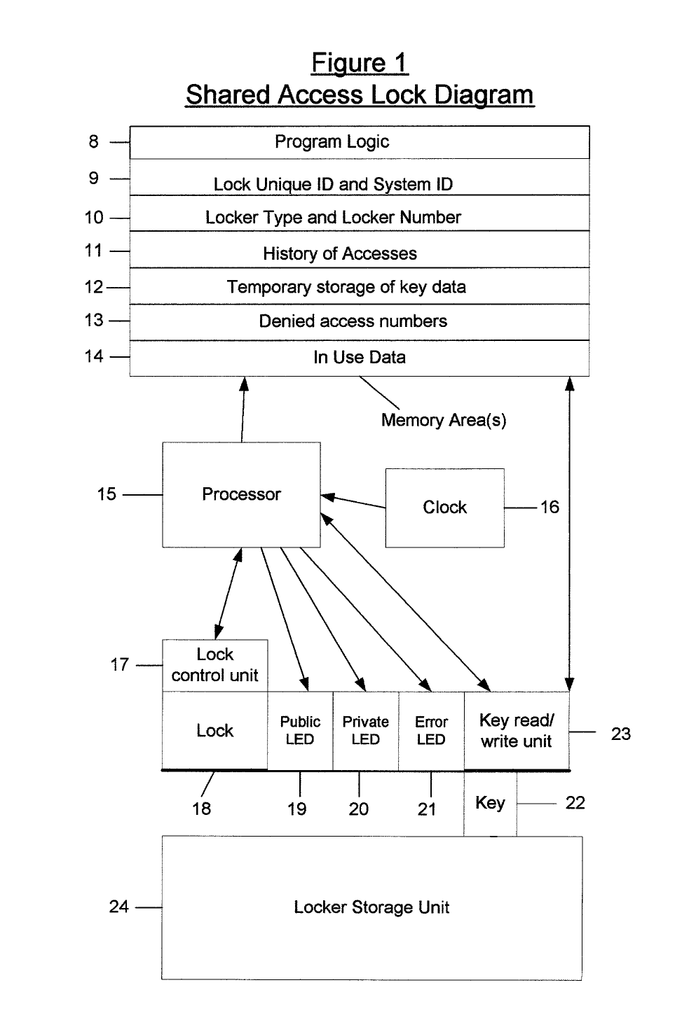

Now, referring to FIG. 1 through 3c, description will be made of a shared access storage locker system according to an exemplary embodiment of the invention. More specifically, the instant embodiment of the invention is directed to a programmed smartcard key operated shared access locker system.

FIG. 1 is a block diagram, a general arrangement of the Shared Access lock

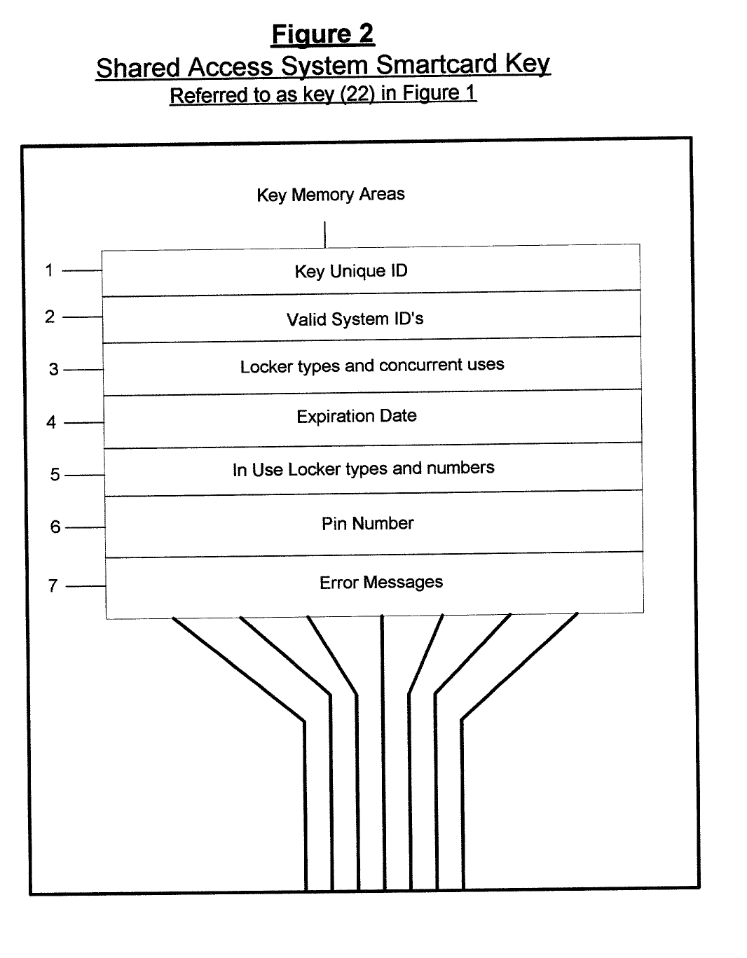

In FIG. 1, the personal storage locker is referenced where 24 represents the locker storage unit, 22 represents the key described in FIG. 2, 23 represents the key read/write unit, 19 represents the public display LED, 20 represents the private display LED, 21 represents the error message display LED, FIG. 18 represents the mechanical lock, FIG. 17 represents the electromechanical device that controls the lock, FIG. 15 represents the processor that compares the data, FIG. 16 represents a real time clock, FIG. 14 represents a memory area that contains information on the current use of the lock, FIG. 13 represents a list of keys refused by this lock, FIG. 12 represents a temporary storage of the data received from the key, FIG. 11 represents a memory area to store the history of lock access, FIG. 10 represents the lock type id and assigned locker number, FIG. 9 represents the lock ID, 8 represents the program logic.

FIG. 2 shows in a block diagram, a general arrangement of the key issued to all users.

In FIG. 2, the key is referenced and 1 represents the card ID memory area, 2 represents the valid system ID memory area, 3 represents the locker types and the concurrent uses allowed memory area, 4 represents the expiration date memory area, 5 represents the locker numbers and their types that are currently in use memory area, 6 represents a pin number memory area, and 7 represents error messages memory area.

In relation to FIG. 1 and 2, a pre-programmed key with an ID written to the Key ID memory area (1), is issued to users of the locker system;

The concept of the system is to issue a key to users of a system of storage lockers placed throughout a physical area and allow them unlimited access to any available (public mode display) locker in the system for storage of personal items and personal transportation vehicles. The user gives their personal information and their request to use certain types of lockers to the key issuer. The issuer prepares a key and writes in the key's Valid System ID's memory area (2) data containing the ID number(s) of all accessible systems, in the Expiration Date memory area (4) a date which the card will expire, in the Locker types and concurrent uses memory area (3), the locker type(s) and number of lockers of that type that may be concurrently occupied, and in the Pin Number memory (6) a pin number chosen by the card holder.

This illustrates a Public to Private mode change:

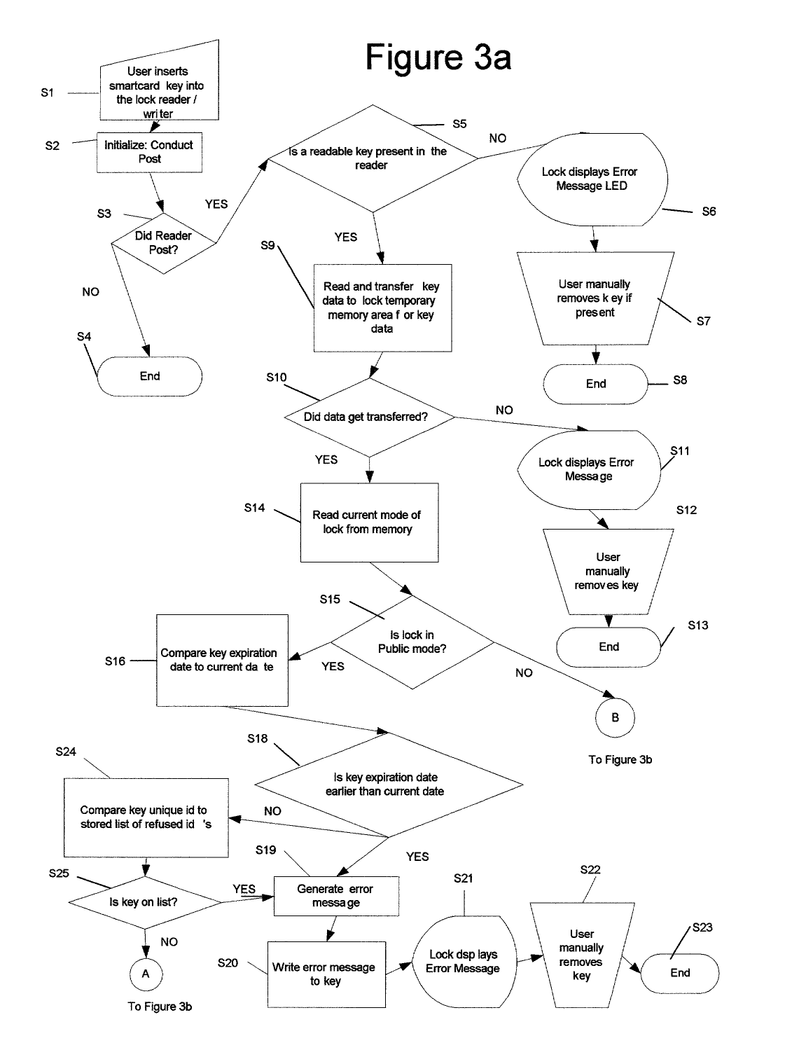

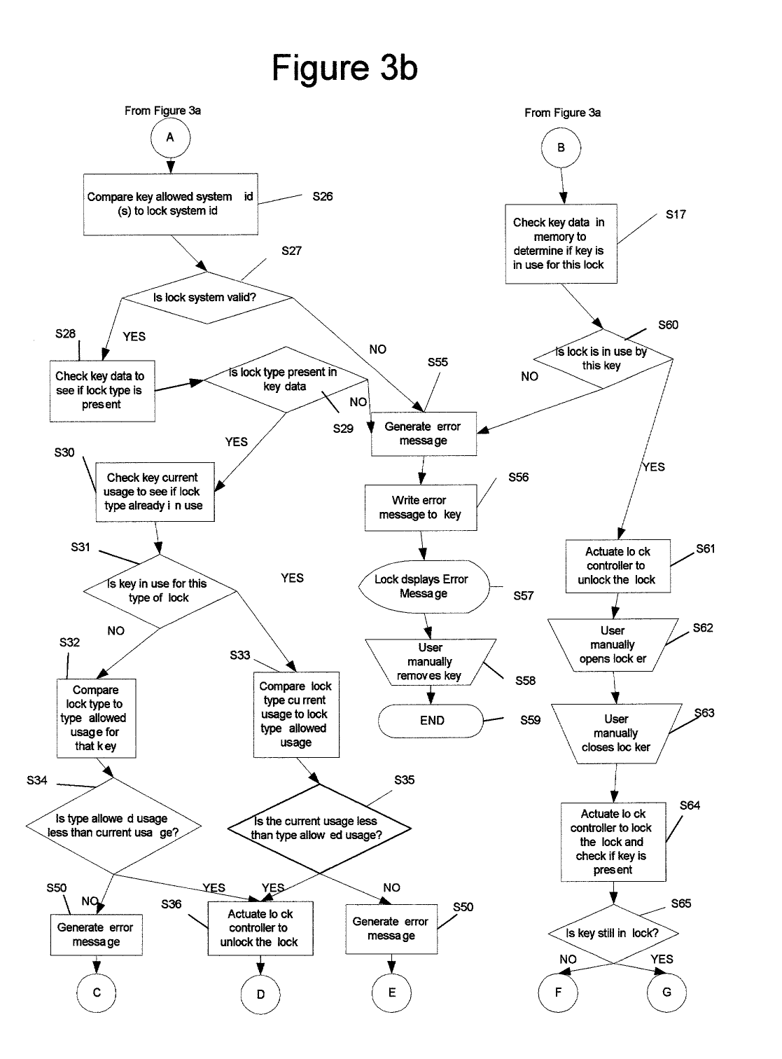

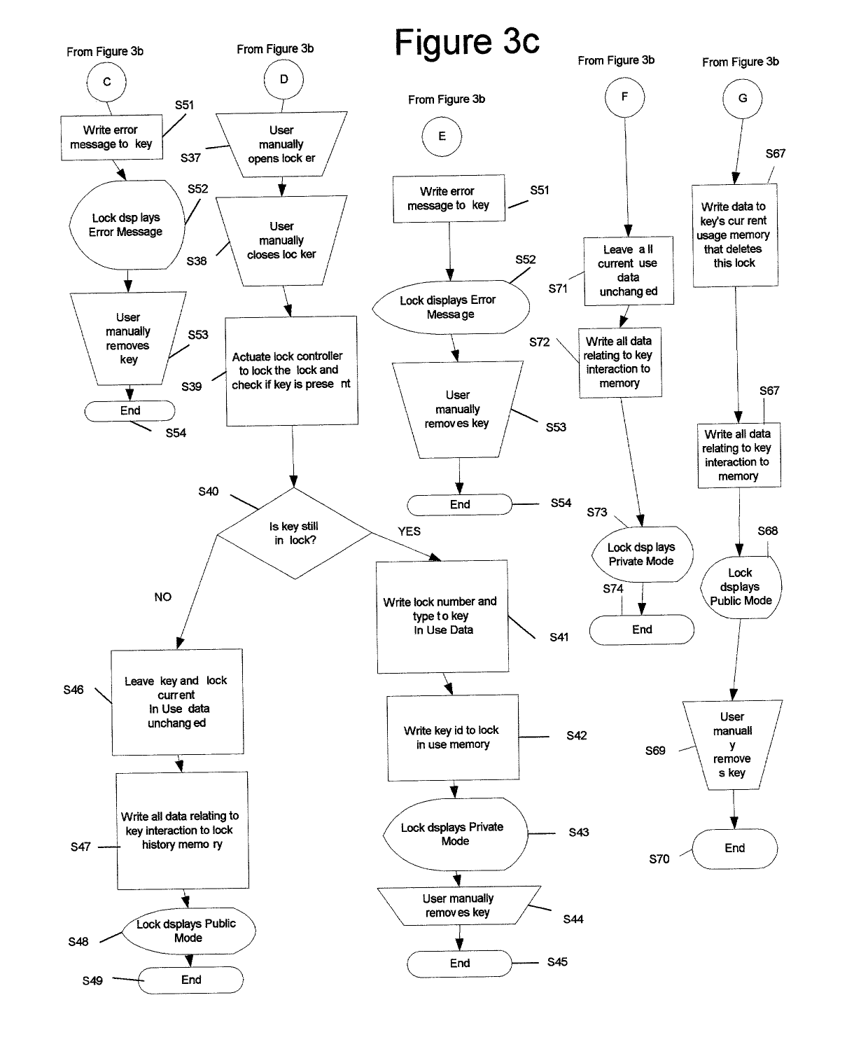

In relation to FIG. 3a, 3b and 3c, and referencing the above scenario, the student will take his programmed personal key 22 and approach a bike storage locker 24 in Public Mode near the building where he has to attend class and insert S1 his key 22 in the key read/write unit 23. The read/write unit 23 will initialize and start the post process S2 and signal S3 the processor 15 when the post S2 is complete and the unit is functioning. If the read/write unit 23 completes post S3, the read/write unit 23 checks S5 to see if a readable key 22 is present in the read/write unit 23. If a readable key 22 is present in the read/write unit 23, the key 22 data is transferred S9 to the temporary storage of key data memory area 12. If the data is successfully transferred S10 the processor 15 then reads the current state of the lock S14 and decides if the lock is in Public or Private mode S15. If the lock is in Public mode, the processor 15 compares S16 the expiration date stored in Temporary storage of key data 12 to the current date received from the clock 16, if the expiration date is greater than the present date S18, the processor 15 compares S24 the Key ID stored in Temporary storage of key data memory area 12 to the denied access numbers memory area 13, if there is no match S25 the processor 15 compares S26 the key allowed system ID(s) in temporary key data storage memory area 12 to the lock system id in the lock ID and System ID memory area 9. If the System ID is present in the key data S27, the processor 15 compares S28 the allowed locker types and concurrent uses stored in the Temporary storage of key data memory area 12 to the locker type stored in Locker Type and Locker Number memory area 10, if the lock type is present S29, the processor will compare S30 the In use locker types and numbers in the Temporary storage of key data memory area 12 to the locker type stored in Locker type and locker number memory area 10, if the key is not in use for this type S31 the processor 15 will compare S32 the locker types and concurrent uses stored in Temporary storage of key data memory area 12 to the lock type stored in Locker Type and Locker Number memory area 10, if the type allowed usage is less than the current usage S34, the lock control unit 17 will actuate and unlock the lock 18. The user will manually open S37 the locker storage unit 24 and insert their articles and then close S38 the locker storage unit 24. The lock control unit 17 will sense when the door is closed and actuate the lock mechanism to lock the locker storage unit 24 and check S39 to see if there is a key 22 present in the reader 23. If a key is present S40, the Key read/write unit 23 will write the lock number and type S41 to the key In Use Locker types and numbers memory area 5. The processor 15 will write the key id to In Use Data memory area 14 and the processor will deactivate the Public LED 19 and activate the Private LED 20 on the display. The user removes S44 his key 22 and the process ends S45.

The student now goes to his classroom and stops to put his book bag in a locker. He forgets to look at the LED display and goes to a locker that is already in use by another user and displays Private mode.

The student will take his programmed personal key 22 and approach a book storage locker 24 in Private Mode in the building where he has to attend class and insert S1 his key 22 in the key read/write unit 23. The read/write unit 23 will initialize and start the post process S2 and signal S3 the processor 15 when the post S2 is complete and the unit is functioning. If the read/write unit 23 completes post S3, the read/write unit 23 checks S5 to see if a readable key 22 is present in the read/write unit 23. If a readable key 22 is present in the read/write unit 23, the key 22 data is transferred S9 to the temporary storage of key data memory area 12. If the data is successfully transferred S10 the processor 15 then reads the current state of the lock S14 and decides if the lock is in Public or Private mode S15. If the lock is in Private mode, the processor 15 compares S17 the Key id stored in the temporary storage of key data memory area 12 to the key id stored in the In Use Data memory area 14. If there is no match S60 the processor will generate an error message S55 and the Key read/write unit 23 will write the error message S56 to the key 22. The locker display will activate S57 the Error Message LED 21 for a short period of time and the user will remove his key S58 and the process ends S59.

The student now finds a book locker in Public mode and goes through the original Public to Private mode change steps he went through to get his bike locker.

The student now comes out of class and goes to the book locker he is using that displays Private mode.

This illustrates a Private to Public mode change:

The student will take his programmed personal key 22 and approach a book storage locker 24 in Private Mode that he is using and inserts S1 his key 22 in the key read/write unit 23. The read/write unit 23 will initialize and start the post process S2 and signal S3 the processor 15 when the post S2 is complete and the unit is functioning. If the read/write unit 23 completes post S3, the read/write unit 23 checks S5 to see if a readable key 22 is present in the read/write unit 23. If a readable key 22 is present in the read/write unit 23, the key 22 data is transferred S9 to the temporary storage of key data memory area 12. If the data is successfully transferred S10 the processor 15 then reads the current state of the lock S14 and decides if the lock is in Public or Private mode S15. If the lock is in Private mode, the processor 15 compares S17 the Key id stored in the temporary storage of key data memory area 12 to the key id stored in the In Use Data memory area 14. If there is a match the lock control unit 17 will actuate S61 and unlock the lock 18. The user will manually open S62 the locker storage unit 24 and insert their articles and then close S63 the locker storage unit 24. The lock control unit 17 will sense when the door is closed and actuate the lock mechanism to lock the locker storage unit 24 and check S64 to see if there is a key 22 present in the reader 23. If a key is present S65, the Key read/write unit 23 will delete the lock number and type S66 from the key In Use Locker types and numbers memory area 5. The processor 15 will delete 67 the key id from In Use Data memory area 14 and the processor 15 will deactivate the Private LED 20 and activate S68 the Public LED 19 on the display. The user removes S69 his key 22 and the process ends S70.

The student now goes back to his bike locker to put his book bag in and take out his gym bag.

The student will take his programmed personal key 22 and approach the bike storage locker 24 in Private Mode that he is using and inserts S1 his key 22 in the key read/write unit 23. The read/write unit 23 will initialize and start the post process S2 and signal S3 the processor 15 when the post S2 is complete and the unit is functioning. If the read/write unit 23 completes post S3, the read/write unit 23 checks S5 to see if a readable key 22 is present in the read/write unit 23. If a readable key 22 is present in the read/write unit 23, the key 22 data is transferred S9 to the temporary storage of key data memory area 12. If the data is successfully transferred S10 the processor 15 then reads the current state of the lock S14 and decides if the lock is in Public or Private mode S15. If the lock is in Private mode, the processor 15 compares S17 the Key id stored in the temporary storage of key data memory area 12 to the key id stored in the In Use Data memory area 14. If there is a match the lock control unit 17 will actuate S61 and unlock the lock 18. The user will manually open S62 the locker storage unit 24 and inserts the book bag and takes out the gym bag and removes his key from the lock and then closes S63 the locker storage unit 24. The lock control unit 17 will sense when the door is closed and actuate the lock mechanism to lock the locker storage unit 24 and check S64 to see if there is a key 22 present in the reader 23. If a key is not present S65, the Key read/write unit 23 will not change any data S71. The processor 15 will write key interaction S72 to History of accesses memory area 11 and the Private LED 20 will remain activated S73 and the process ends S74.

Now the student goes to the gym and goes to a locker displaying Public mode. He inserts his key and opens the locker, but it is dirty, so he removes his key and closes it and goes to another locker in Public mode. He uses this locker in the same Public to private mode change manner he successfully used at a book locker earlier and then returns and releases the locker back to public mode.

The student will take his programmed personal key 22 and approach a gym locker 24 in Public Mode in the locker room and inserts S1 his key 22 in the key read/write unit 23. The read/write unit 23 will initialize and start the post process S2 and signal S3 the processor 15 when the post S2 is complete and the unit is functioning. If the read/write unit 23 completes post S3, the read/write unit 23 checks S5 to see if a readable key 22 is present in the read/write unit 23. If a readable key 22 is present in the read/write unit 23, the key 22 data is transferred S9 to the temporary storage of key data memory area 12. If the data is successfully transferred S10 the processor 15 then reads the current state of the lock S14 and decides if the lock is in Public or Private mode S15. If the lock is in Public mode, the processor 15 compares S16 the expiration date stored in Temporary storage of key data 12 to the current date received from the clock 16, if the expiration date is greater than the present date S18, the processor 15 compares S24 the Key ID stored in Temporary storage of key data memory area 12 to the denied access numbers memory area 13, if there is no match S25 the processor 15 compares S26 the key allowed system ID(s) in temporary key data storage memory area 12 to the lock system id in the lock ID and System ID memory area 9. If the System ID is present in the key data S27, the processor 15 compares S28 the allowed locker types and concurrent uses stored in the Temporary storage of key data memory area 12 to the locker type stored in Locker Type and Locker Number memory area 10, if the lock type is present S29, the processor will compare S30 the In use locker types and numbers in the Temporary storage of key data memory area 12 to the locker type stored in Locker type and locker number memory area 10, if the key is not in use for this type S31 the processor 15 will compare S32 the locker types and concurrent uses stored in Temporary storage of key data memory area 12 to the lock type stored in Locker Type and Locker Number memory area 10, if the type allowed usage is less than the current usage S34, the lock control unit 17 will actuate and unlock the lock 18. The user will manually open S37 the locker storage unit 24 and seeing that it is dirty, he removes his key and then closes S38 the locker storage unit 24. The lock control unit 17 will sense when the door is closed and actuate the lock mechanism to lock the locker storage unit 24 and check S39 to see if there is a key 22 present in the reader 23. If a key is not present S40, if a key is not present, the Key read/write unit 23 will not change any data S46. The processor 15 will write key interaction S47 to History of accesses memory area 11 and the Public LED 19 will remain activated S48 and the process ends S49.

The student now leaves the gym to pick up his bike and book bag and go home.

The student will take his programmed personal key 22 and approach a bike storage locker 24 in Private Mode that he is using and inserts S1 his key 22 in the key read/write unit 23. The read/write unit 23 will initialize and start the post process S2 and signal S3 the processor 15 when the post S2 is complete and the unit is functioning. If the read/write unit 23 completes post S3, the read/write unit 23 checks S5 to see if a readable key 22 is present in the read/write unit 23. If a readable key 22 is present in the read/write unit 23, the key 22 data is transferred S9 to the temporary storage of key data memory area 12. If the data is successfully transferred S10 the processor 15 then reads the current state of the lock S14 and decides if the lock is in Public or Private mode S15. If the lock is in Private mode, the processor 15 compares S17 the Key id stored in the temporary storage of key data memory area 12 to the key id stored in the In Use Data memory area 14. If there is a match the lock control unit 17 will actuate S61 and unlock the lock 18. The user will manually open S62 the locker storage unit 24 and insert their articles and then close S63 the locker storage unit 24. The lock control unit 17 will sense when the door is closed and actuate the lock mechanism to lock the locker storage unit 24 and check S64 to see if there is a key 22 present in the reader 23. If a key is present S65, the Key read/write unit 23 will delete the lock number and type S66 from the key In Use Locker types and numbers memory area 5. The processor 15 will delete 67 the key id from In Use Data memory area 14 and the processor 15 will deactivate the Private LED 20 and activate S68 the Public LED 19 on the display. The user removes S69 his key 22 and the process ends S70.

A standard commercially available data collection unit may be inserted into the key read/write unit 22 to download the history file and upload the refused ID list.

Optionally, a standard commercially available wireless transceiver may be used to download the history file and upload the refused ID list in lieu of the manual collection unit.

A standard commercially available smartcard key reader will be available to the key holders. This unit will allow the user to insert their card, enter their PIN via the manual keypad and view their key information including the Valid System ID's, the locker types and concurrent uses, the expiration date, the In Use Locker types and numbers and error messages.

What is claimed is:

1. A door lock control apparatus for use in a shared access locker storage system accessed with a smartcard key, comprising:
a key memory area containing a key ID, a System ID, locker type and concurrent use, a expiration date, in use data, a PIN number and an error message memory area
an article storage unit, which accommodates articles, including;
a bimodal lock with Public and Private modes controlled by smartcard key interaction with the lock logic, memory and processor,
a lock containing all necessary logic to enforce system rules without communication between any other lock or a central system,
a door control unit that contains a key reader/writer which reads and writes key information,
an information storing unit which stores the information read from the key inserted into said key reader/writer;
an information storing unit, which stores the information of the lock identification information,
a microcomputer which compares the key information stored in said information storing unit with the information stored in the lock information storing unit, wherein
a lock controller which controls unlocking and locking of a door of said personal storage unit.

3. A bimodal lock unit according to claim 1, with a display to indicate the current mode of the lock.

4. A shared access storage locker system according to claim 1, wherein the current date and time are calculated by an internal clock.

5. A shared access storage locker system according to claim 1, further comprising: a manual reader device that is inserted into said card reader/writer to collect and upload information to the lock unit.

6. A shared access storage locker system according to claim 1, wherein a wireless transceiver may be installed to facilitate the transfer of information from each lock to the information collection unit.
